(19) United States
(12) Patent Application Publication
(10) Pub. No.: US 2003/0188153 A1
(43) Pub. Date: Oct. 2, 2003

(54) System and method for mirroring data using a server

(76) Inventors: Jeff S. Demoff, Erie, CO (US); Carol Harrisville-Wolff, Louisville, CO (US); Alan S. Wolff, Louisville, CO (US)

Correspondence Address: HOGAN & HARTSON LLP, ONE TABOR CENTER, SUITE 1500, 1200 SEVENTEEN ST., DENVER, CO, 80202, US

(21) Appl. No.: 10/114,521

(22) Filed: Apr. 2, 2002

(51) Int. Cl. H04L 9/00

(52) U.S. Cl. 713/153

(57) ABSTRACT

A system and method for mirroring data using a server is disclosed. The system is a network having a plurality of client systems coupled to the server, known as a storage management server. The storage management server has a distributor module that executes against a data structure stored on the server. The distributor module randomly partitions the data structure into data fragments. A set of memory locations are allocated on the client systems. A memory location is unused memory on the client system. The distributor module stores the randomly partitioned data structures at the memory locations. The data fragments can be encrypted before storage for additional security. The locations of the data fragments and any encryption keys are stored on the storage management server such that the data structure can be reconstructed by the data fragments when requested. The system also includes a backup server to store the locations and encryption keys to reconstruct the data structure, if desired.

### BACKGROUND OF THE INVENTION

1. Field of the Invention

The present invention relates to network systems having a server to distribute data within the network and, more particularly, the invention relates to a server within a network of client systems having memory resources that are mirrored by the server.

2. Discussion of the Related Art

Data storage requirements affect network resources and memory space. As more data and information is received and produced on networks, the storage needs also increase. For example, users and client systems on a network may produce thousands of emails, graphic files, text files, executable code and the like on a given day. Further, all this information may need to be saved in a separate location to serve as backup data to the main storage.

Backup and recovery of data within network, or information technology, systems may require expensive and complicated processes and technologies. The process of “mirroring” data may involve numerous systems and software management consoles to prepare the data for a data loss event. Backup data may reside on a separate server that is accessed during data loss. This solution, however, may be expensive, time-consuming, or restricted by space. Thus, many companies with networks can have insufficient backup stores or policies.

### SUMMARY OF THE INVENTION

Accordingly, the present invention is directed to a system and method for mirroring data from a server over a network having client systems.

Additional features and advantages of the invention will be set forth in the disclosure that follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the present invention discloses a storage management server within a network having client systems coupled to the storage management server. The storage management server includes a data structure stored at the storage management server. The storage management server also includes a distributor module to randomly divide the data structure into a plurality of data fragments and to store the plurality of data fragments at the client systems. The storage management server also includes encryption keys to encrypt each of the plurality of data fragments. The storage management server also includes a data file stored at the storage management server. The data file includes the locations of the plurality of data fragments and the encryption keys.

Further, a method for mirroring data on a storage management server within a network having client systems is disclosed. The method includes executing a distributor module against a data structure on the storage management server. The method also includes randomly generating a plurality of data fragments from the data structure. The method also includes allocating a set of memory locations within the client systems. The method also includes storing the plurality of data fragments at the set of memory of locations.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the invention and are incorporated in and constitute a part of this specification, illustrate embodiments of the invention and together with the description serve to explain the principles of the invention. In the drawings:

FIG. 1 illustrates a server network in accordance with an embodiment of the present invention.

FIG. 2 illustrates a server network in accordance with another embodiment of the present invention.

FIG. 3 illustrates a flowchart for mirroring data within a server in accordance with an embodiment of the present invention.

FIG. 4 illustrates a flowchart for reconstructing a fragmented and mirrored data structure in accordance with an embodiment of the present invention.

### DETAILED DESCRIPTION OF THE PREFERRED EMBODIMENTS

Reference will now be made in detail to the preferred embodiments of the present invention, examples of which are illustrated in the accompanying drawings.

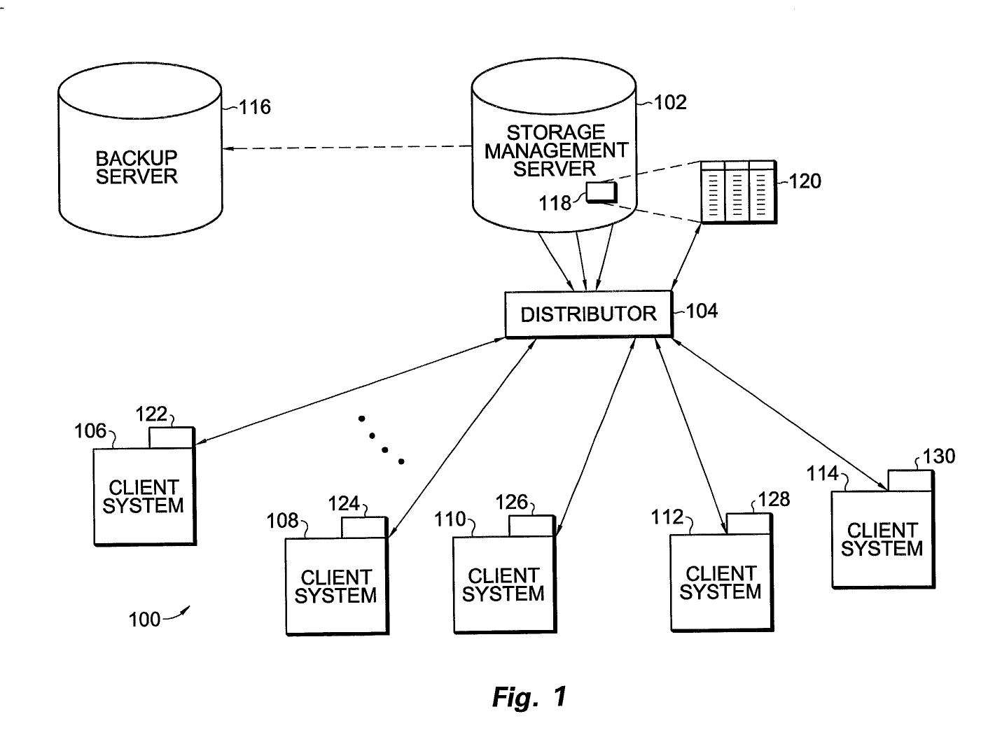

FIG. 1 depicts a server network 100 in accordance with an embodiment of the present invention. Server network 100 includes storage management server 102 that distributes, coordinates, and exchanges information, data, files, programs, and the like with client systems 106, 108, 110, 112, and 114. Server network 100 may be implemented in any setting where a server is coupled to client systems, and is not limited in its implementation. Server network 100 also includes backup server 116 that is coupled to storage management server 102.

Client systems 106, 108, 110, 112, and 114 are linked to storage management server 102. Client systems 106, 108, 110, 112, and 114 may be any device, system, or platform that has memory, a processor to access the memory. Preferably, client systems 106-114 are desktop computers linked to server 102. Alternatively, client systems 106-114 may be any combination of desktops, laptops, personal digital assistants, wireless computing devices, portable phones, and the like. Further, the number of client systems is not limited to the number depicted in FIG. 1. Server network 100 may have N number of client systems.

Storage management server 102 may be any known server or server architecture that can store programs, data and information. Storage management server 102 may include a memory 118 that stores a file structure 120. Memory 118 also may be known as a memory location. Storage management server 102 may be operated by an administrator for server network 100. Storage management server 102 may distribute information, data, and programs to client systems 106-114 according to instructions or protocols. For example, storage management server 102 may store and manage documents that are accessed by a word processing program on client systems 106-114. Storage management server 102 uses backup 116 for redundancy and data mirroring.

Client systems 106-114 may have a certain amount of memory, such as disk space, that is being used. Client systems 106-114 also have a certain amount of memory that is not being used. For example, client system 106 may have 1 gigabyte of disk space and is using about 200 megabytes of the disk space for its applications and data storage. Storage management server 102 may access the memory resources within client system 106 to save data, programs and other information. Storage management server 102 may store data, programs and other information to all client systems with server network 100. In addition, storage management server 102 may store a file to client system 108, but not to client system 110.

Storage management server 102 also may be responsible for redundancy and data mirroring of stored files, programs, data, and other information. These operations may be performed for security and disaster recovery in case storage management server 102 fails. If storage management server 102 becomes unavailable, server network 100 will need to reconstruct the data, programs, files and other information that was stored on storage management server 102 to continue to service client systems 106-114.

Storage management server 102 also includes distributor module 104 that facilitates redundancy and data mirroring on server network 100. Distributor module 104 may be an executable program that seeks to distribute fragments, or bits of data, of files to storage resources of the client systems linked to storage management server 102. Distributor module 104 may be used as an alternative to conventional data backup. Distributor module 104 places fragments of data from programs, files and the like in the unused memory of client systems 106-114. Thus, space on storage management server 102 and/or backup server 116 is saved, and fallow memory, storage, or resources within server network 100 are utilized.

Preferably, distributor module 104 resides on storage management server 102. Alternatively, storage management server 102 may invoke distributor module 104 from another location within server network 100. Distributor module 104 is requested to execute against a file structure, such as file structure 120. File structure 120 may be a data file, a program, a code listing, or other stored information. Distributor module 104 will divide, or partition, file structure 120 into a certain number of fragments. Preferably, file structure 120 is divided randomly. Further, server network 100 may desire a specified amount of redundancy for the fragments of file structure.

Distributor module 104 may partition file structure 120 into data, or bit, fragments 122, 124, 126, 128, and 130 that are stored on client systems 106, 108, 110, 112, and 114, respectively. As noted above, each client system should have a certain amount of unused disk space. Distributor module 104 via storage management server 102 may claim a certain amount of this disk space, or memory locations, for storing data fragments. For example, 10 megabytes of the disk space of client system 106 may be claimed by distributor module 104 to store data fragment 122. Client system 106 still has a majority of its disk space available. Thus, random data fragments 122-130 may be placed by distributor module 104 on client systems 106-114 within server network 100.

As noted above, server network 100 may have N number of client systems. Distributor module 104 may divide file structure 120 into N fragments, or any subset thereof, as determined by the network administrator, server network 100, or storage management server 102. Further, storage management server 102 may use distributor module 104 to reconstruct, or rebuild, file structure 120 from the distributed data fragments at any time. Data fragments 122-130 by themselves are useless because they are not complete programs or sets of data. Moreover, data fragments 122-130 may be distributed in a random manner determined by distributor module 104. For example, client system 112 should not know how the other data fragments are distributed throughout server network 100 by data fragment 128.

Data fragments 122-130 also may be encrypted by distributor module 104 prior to storing on client systems 106-114. Encryption may enhance security of the stored fragments as users of the client systems are not be able to decrypt the stored data. The encryption keys may be stored by distributor module 104 on storage management server 102. Thus, the stored data fragments 122-130 may be divided and distributed in a random manner, and encrypted. These features enhance the security of the distributed fragments of file structure 120. Moreover, distributor module 104 preferably distributes the data fragments without notifying the users of client systems 106-114. The distribution and storing operations for data fragments 122-130 may occur seamlessly by using the resources of server network 100 in conjunction with storage management server 102.

After the data fragments are distributed, distributor module 104 has an order and locations for the randomly assigned data fragments and encryption codes. The order, locations and encryption codes may be stored on storage management server 102. For redundancy and disaster recovery, the order and locations for the data fragments and the encryption codes also may be stored on backup server 116. If storage management server 102 goes offline, data fragments 122-130 may be reconstructed by distributor module 104 from the backup data files stored on backup server 116. The data files for fragmented data structure 120 may be considerably smaller than data structure 120, and, therefore, should not require as much memory or storage space on storage management server 102. For example, the order, location, and encryption data file for data structure 120 may be about 1 kilobyte. Thus, storage requirements for files on storage management server 102 may be reduced and resources within server network 100 may be utilized more efficiently.

Preferably, distributor module 104 should fragment data structures, such as data structure 120, that are not critical to server network 100. Storage management server 102 may still backup critical programs, files and data as normal on backup server 116. Distributor module 104 may be used to supplement normal backup procedures and to alleviate storage demands for smaller, less critical files. Critical files, however, may be partitioned and mirrored by distributor module 104, as disclosed above. Distributor module 104 may be executed on command from an administrator, or may execute on files below a specified size, such as 10 megabytes. Further, storage management server 102 may store pieces of data, programs, or files from another system, and is not limited to the functions disclosed. Storage management server 102 also may run multiple distributor modules that fragment and store data over networks. Moreover, storage management server 102 may serve as a backup server to another server.

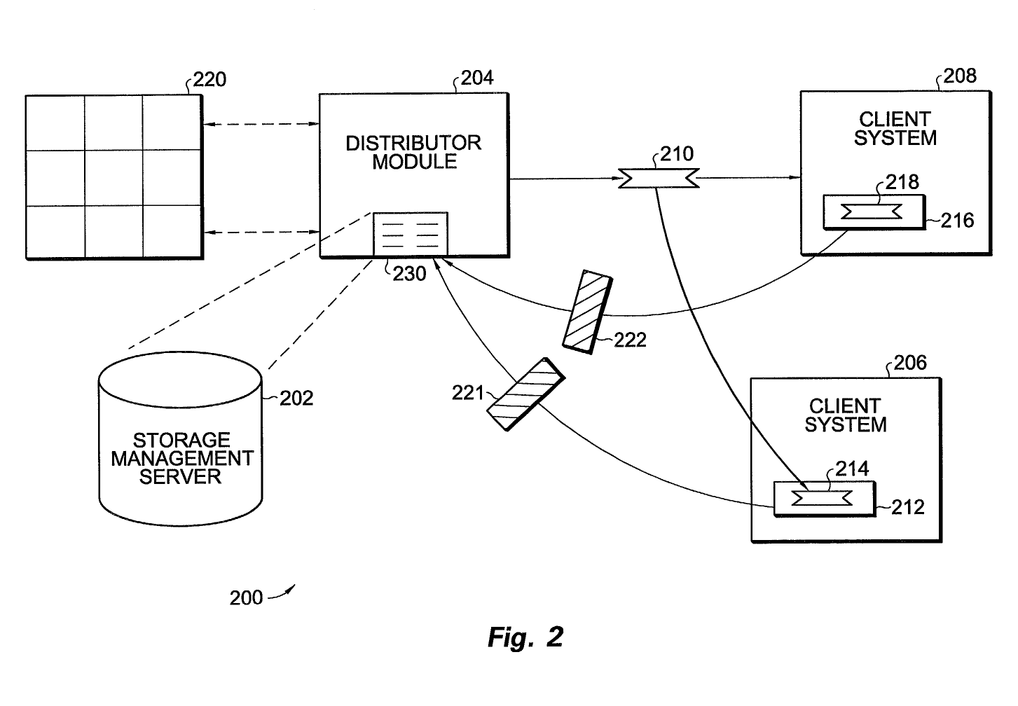

FIG. 2 depicts a server network 200 in accordance with another embodiment of the present invention. Server network 200 correlates to server network 100 of FIG. 1. Server network 200 includes storage management server 202. Distributor module 204 may reside and execute on storage management server 204. Server network 200 also includes client systems 206 and 208. Server network 200 also may include additional client systems linked to storage management server 202.

Distributor module 204 randomly may divide data structure 220 into data fragments, as disclosed above. Data structure 220 may be divided into N number of data fragments and then assigned by distributor module 204 to memory locations on the client systems within server network 200. The random data fragments also may be encrypted by distributor module 204.

Data fragment 210 is one of the randomly assigned data fragments of data structure 220. Data fragment 210 is a subset of bits of data from data structure 220. Distributor module 204 encrypts and assigns data fragment 210 to client system 206. Client system 206 includes memory 212, that stores data fragment 210 as data block 214. Memory 212 also may be known as a memory locaion within client system 206. Data block 214 may be an encrypted copy of data fragment 210. After data block 214 is created within memory 212, storage data 220 may be sent to distributor module 204.

Distributor module 204 places storage data 220 into memory 230 that correlates to storage data for fragmented data structure 220. Storage data 220 also may include any encryption codes for data block 212.

Distributor module 204 also may provide redundancy for data structure 220 within server network 200. Data fragment 210 also may be stored as data block 218 on client system 208. Client system 208 is linked to distributor module 204 as well, and includes memory, or memory location, 216. Data block 218 also may be an encrypted copy of data fragment 210. After data block 218 is created within memory 216, storage data 222 may be sent to distributor module 204. Distributor module 204 places storage data 222 into memory 230. As noted above, memory 230 provides space for storage data of fragmented data structure 220. Storage data 222 also may include any encryption codes for data block 218. Preferably, memory 230 resides on storage management server 202.

If client system 206 were to be compromised or taken off-line for any reason, distributor module 204 can reconstruct data structure 220 with data block 218 from client system 208. Data fragment 210 may be saved on several client systems for additional redundancy if server network 200 desires. If client system 206 subsequently becomes available, then distributor module 204 may return to data block 214 in retrieving data fragment 210.

Memories 212 and 216 may be memory storage space on disk drives within client systems 206 and 208, respectively. As noted above, data fragments may be stored at a memory location within the disk drive memories by distributor module 204. Preferably, a user to a client system, such as client system 206, will not be aware that data fragments are being stored. Further, the user should not have access to the memory location, such as memory 212, from the operating system, graphical user interfaces, file listings, or the like on client system 206. Distributor module 204, through storage management server 202, may set aside memories 212 and 216 for data storage on client systems 206 and 208. Preferably, only distributor module 204 has access to memories 212 and 216. Memories 212 and 216 may not be written over by client systems 206 and 208. These features enhance security for the stored data and provide distributor module 204 access to a set amount of memory storage space on each client system.

The file stored in memory 230 for reconstructing data structure 220 also may be stored, or backed up, on a backup server. Alternatively, the file stored in memory 230 may be stored by any known recovery or data mirroring system. Thus, if storage management server 202 crashes or goes off-line, then the file to reconstruct data structure 220 may still be accessed and all the information regarding the data fragments is not lost.

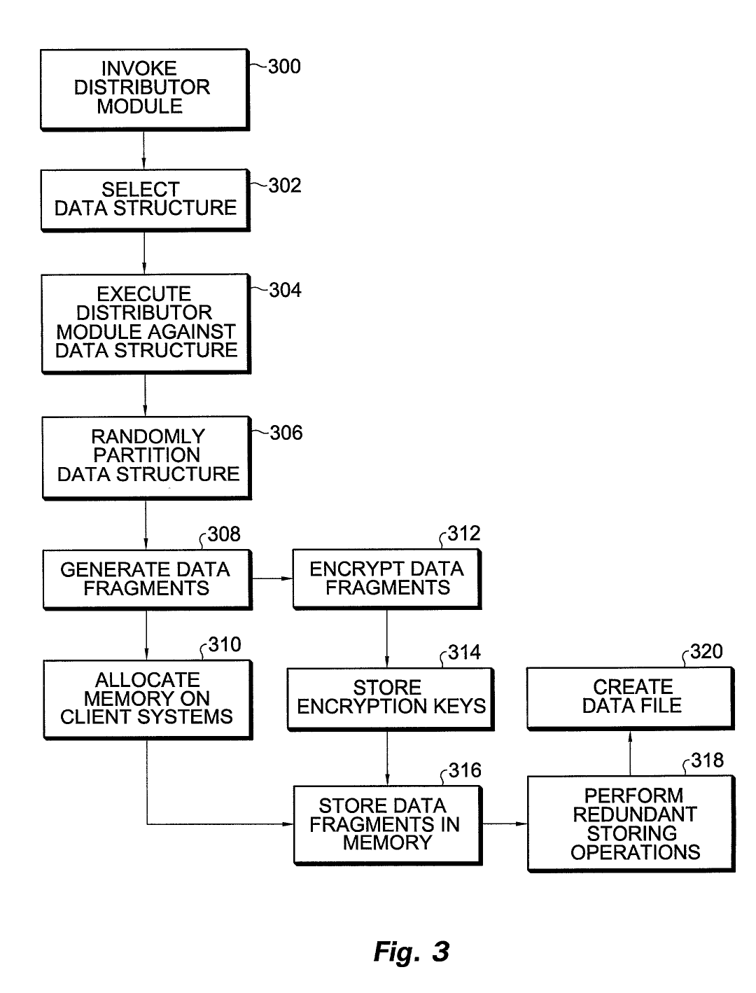

FIG. 3 depicts a flowchart for mirroring data within a server in accordance with an embodiment of the present invention. Step 300 executes by invoking a distributor module stored on the server, such as storage management server 102. The distributor module may be invoked by a system administrator, user, or by protocols or programs on the server. Step 302 executes by selecting a data structure to be mirrored. The data structure may be an executable program, a data file, a database, and the like.

Step 304 executes by executing the distributor module against the selected data structure. Again, the distributor module may be executed by a command from a system administrator, user, or by protocols or programs on the server. Step 306 executes by randomly partitioning the selected data structure according to the distributor module. The data structure may be separated into distinct bits of data in a random manner determined by the distributor module. Individually, the distinct bits are inoperable, and should not contain an executable program or data file. Step 308 executes by creating the data fragments to be stored on the client systems. The number of data fragments, preferably, should correlate to a subset of the number of client systems available.

Step 310 executes by allocating the memory locations on the client systems for use by the distributor module. Preferably, the memory space already has been set aside for data mirroring operations. The memory should be unused disk space on the client systems. Step 312 executes by encrypting the data fragments using an encryption key for each fragment. The data fragments are encrypted for added security so that if someone accesses the memory within the client system, then the data will not be compromised. Step 314 executes by storing the encryption keys in memory on the server.

Step 316 executes by storing the encrypted data fragments in the allocated memory at the client systems. The stored data fragments also may be known as data blocks. The assignment of the data fragments to the client systems also may be done in a random manner by the distributor module. The distributor module also may assign the data fragments according to a set of instructions from the storage management server.

Step 318 executes by performing redundant storing operations. The distributor module may be tasked to create a certain amount of redundancy for the fragmented data structure. For example, if the desired redundancy is four, then the distributor module will store the data fragments four times on different client systems. Thus, if one client system is compromised or taken off-line, then a redundantly stored data fragment may be accessed to provide the necessary data. Step 320 executes by creating a data file at the server for the fragmented and mirrored data structure. The data file may include the memory locations of the stored data blocks for the data fragments and the encryption keys for the data fragments.

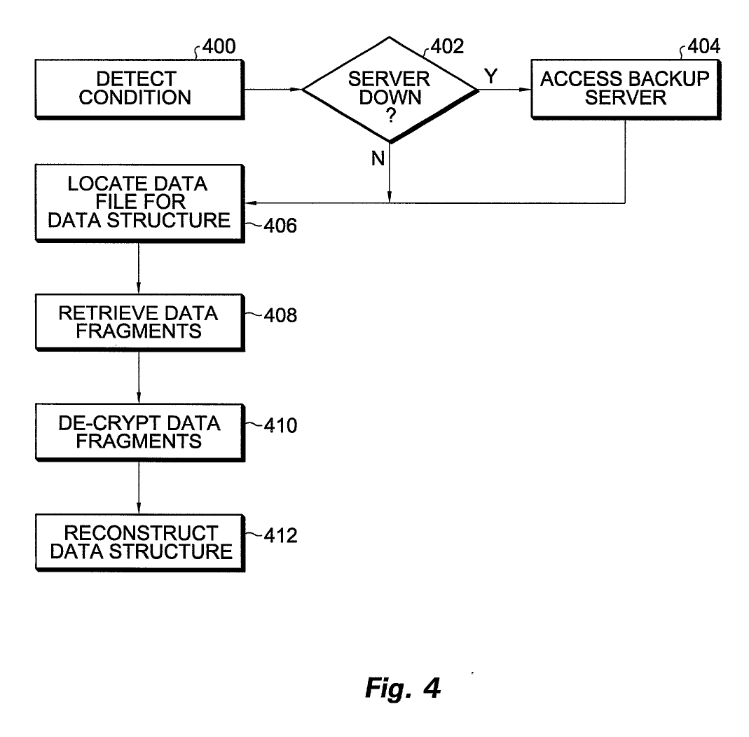

FIG. 4 depicts a flowchart for reconstructing a fragmented and mirrored data structure in accordance with an embodiment of the present invention. Step 400 executes by detecting a condition that results in a distributed, fragmented data structure being reconstructed. The condition may be a request from the system, an administrator, a user and the like. The condition also may be a failure of one of the network components, such as the storage management server or a client system. The condition may be any action or state that results in the data structure being reconstructed from the data fragments and placed back into memory at the server.

Step 402 executes by determining whether the condition is a result of the storage management server being down, off-line, or compromised. If yes, then step 404 executes by accessing a backup server for a data file or other stored information that includes the locations of the stored data fragments and any applicable encryption codes. If the storage management server is unavailable, then any information regarding reconstructing the data structure should be available at another location, preferably a backup server.

Step 406 executes by locating the data file for the applicable data structure to be reconstructed. As noted above, the data file should include memory locations of the stored copies of the data fragments and any encryption keys. Step 408 executes by retrieving the data fragments according to the locations assigned by the distributor module. The data fragments should be stored in memory on disk drives in various client systems, such as computers linked to the server. Step 410 executes by de-crypting the retrieved data fragments according to the encryption keys. Step 412 executes by reconstructing the randomly fragmented data structure according the order determined by the distributor module.

It will be apparent to those skilled in the art that various modifications and variations can be made in the wheel assembly of the present invention without departing from the spirit or scope of the invention. Thus, it is intended that the present invention covers the modifications and variations of this invention provided that they come within the scope of any claims and their equivalents.

What is claimed:

1. A storage management server within a network having client systems coupled to said storage management server, comprising:
a data structure stored at said storage management server;
a distributor module to randomly divide said data structure into a plurality of data fragments and to store said plurality of data fragments at said client systems;
encryption keys to encrypt each of said plurality of data fragments; and
a data file stored at said storage management server having locations of said plurality of data fragments and said encryption keys.

2. The storage management server of claim 1, further comprising a memory to store said data file.

3. The storage management server of claim 1, wherein said distributor module comprises software code.

4. The storage management server of claim 3, wherein said software code resides on said storage management server.

5. The storage management server of claim 1, wherein said distributor module copies said plurality of said data fragments into a redundant plurality of data fragments.

6. The storage management server of claim 1, further comprising a memory location on a disk drive within each of said client systems to store each of said plurality of said data fragments.

7. A system for managing data between a plurality of client systems, including a first client system, comprising:
a storage management server coupled to store data from said client systems;
a distributor module to randomly generate a first data fragment from a plurality of data fragments of a data structure stored at said storage management server;
a first encryption key to encrypt said first data fragment; and
a first memory location within said first client system to store said first data fragment.

8. The system of claim 7, wherein said distribution module resides on said storage management server.

9. The system of claim 7, further comprising a data file stored at said storage management server, said data file comprising said first memory location and said first encryption key.

10. The system of claim 8, further comprising a backup server coupled to said storage management server to store a backup data file correlating to said data file.

11. The system of claim 7, further comprising a backup server coupled to said storage management server.

12. The system of claim 7, further comprising a second client system coupled to said storage management server.

13. The system of claim 12, further comprising a second data fragment randomly generated from said plurality of data fragments.

14. The system of claim 13, further comprising a second memory location within said second client system to store said second data fragment.

15. The system of claim 13, further comprising a second encryption key to encrypt said second data fragment.

16. The system of claim 13, wherein said second data fragment is a copy of said first data fragment, such that said second client system is redundant to said first client system.

17. The system of claim 7, wherein said distributor module reconstructs said data structure using said first data fragment stored at said first memory location.

18. A method for mirroring data on a storage management server within a network having client systems, comprising:
executing a distributor module against a data structure on said storage management server;
randomly generating a plurality of data fragments from said data structure;
allocating a set of memory locations within said client systems; and
storing said plurality of data fragments at said set of memory locations.

19. The method of claim 18, further comprising encrypting said plurality of said data fragments.

20. The method of claim 19, wherein said encrypting includes using encryption keys for each of said plurality of data fragments.

21. The method of claim 19, wherein said randomly generating includes partitioning said data structure into said plurality of data fragments.

22. The method of claim 18, further comprising selecting said data structure from said storage management server.

23. The method of claim 18, further comprising invoking said distributor module from said storage management server.

24. The method of claim 18, further comprising performing redundant storing operations on said plurality of data fragments.

25. The method of claim 24, wherein said performing includes storing said plurality of data fragments at another set of memory locations within said client systems.

26. The method of claim 18, further comprising creating a data file for said set of memory locations.

27. The method of claim 26, further comprising storing said data file on said storage management server.

28. The method of claim 18, further comprising reconstructing said data structure from said plurality of data fragments with said distributor module.

29. A method for coordinating data within a network having a server coupled to client systems, comprising:
invoking a distributor module to partition a data structure within said server to randomly generate data fragments that include bits of data from said data structure;
encrypting each of said data fragments according to encryption keys;
allocating memory locations on a first set of client systems; storing said data fragments at said memory locations on said first set of client systems;
allocating memory locations on a second set of client systems;
storing said data fragments at said memory locations on said second set of client systems; and
creating a data file on said server to store said memory locations and encryption keys for said data fragments.

30. The method of claim 29, further comprising storing said data file on a backup server coupled to said server.

31. The method of claim 29, further comprising reconstructing said data structure from said data fragments stored at said memory locations on said first set of client systems.

32. The method of claim 31, further comprising accessing a memory location from said second set of client systems when a correlating memory location from said first set of client systems is unavailable.

33. A method for accessing a partitioned data structure within a network, comprising:
locating a data file for said data structure;
retrieving data fragments from memory locations identified in said data file;
de-crypting said data fragments according to encryption keys in said data file; and
reconstructing said data structure with said data fragments with a distributor module.

34. The method of claim 33, further comprising detecting a condition at a server storing said distributor module to access said data structure.

35. The method of claim 33, further comprising storing said data structure within memory on a server hosting said distributor module.

36. A method for mirroring data on a server within a network, comprising:
executing a distributor module residing on said server;
partitioning a data structure on said server in a random manner;
generating at least one data fragment from said partitioning; and
storing said at least on data fragment within memory locations coupled to said network, wherein said memory locations are assigned by said distributor module.

37. A system for mirroring data on a storage management server within a network having client systems, comprising:
means for executing a distributor module against a data structure on said storage management server;
means for randomly generating a plurality of data fragments from said data structure;
means for allocating a set of memory locations within said client systems; and
means for storing said plurality of data fragments at said set of memory locations.

38. A computer program product comprising a computer useable medium having computer readable code embodied therein for mirroring data on a storage management server within a network having client systems, the computer program product adapted when run on a computer to execute steps, including:
executing a distributor module against a data structure on said storage management server;
randomly generating a plurality of data fragments from said data structure;
allocating a set of memory locations within said client systems; and
storing said plurality of data fragments at said set of memory locations.

39. A system for coordinating data within a network having a server coupled to client systems, comprising:
means for invoking a distributor module to partition a data structure within said server to randomly generate data fragments that include bits of data from said data structure;
means for encrypting each of said data fragments according to encryption keys;
means for allocating memory locations on a first set of client systems;
means for storing said data fragments at said memory locations on said first set of client systems;
means for allocating memory locations on a second set of client systems;
means for storing said data fragments at said memory locations on said second set of client systems; and
means for creating a data file on said server to store said memory locations and encryption keys for said data fragments.

40. A computer program product comprising a computer useable medium having computer readable code embodied therein for coordinating data within a network having a server coupled to client systems, the computer program product adapted when run on a computer to execute steps, including:
invoking a distributor module to partition a data structure within said server to randomly generate data fragments that include bits of data from said data structure;
encrypting each of said data fragments according to encryption keys;
allocating memory locations on a first set of client systems;
storing said data fragments at said memory locations on said first set of client systems;
allocating memory locations on a second set of client systems;
storing said data fragments at said memory locations on said second set of client systems; and
creating a data file on said server to store said memory locations and encryption keys for said data fragments.

41. A system for accessing a partitioned data structure within a network, comprising:
means for locating a data file for said data structure;
means for retrieving data fragments from memory locations identified in said data file;
means for de-crypting said data fragments according to encryption keys in said data file; and
means for reconstructing said data structure with said data fragments with a distributor module.

42. A computer program product comprising a computer useable medium having computer readable code embodied therein for accessing a partitioned data structure within a network, the computer program product adapted when run on a computer to execute steps, including:
locating a data file for said data structure;
retrieving data fragments from memory locations identified in said data file;
de-crypting said data fragments according to encryption keys in said data file; and
reconstructing said data structure with said data fragments with a distributor module.

43. A system for mirroring data on a server within a network, comprising:
means for executing a distributor module residing on said server;
means for partitioning a data structure on said server in a random manner;
means for generating at least one data fragment from said partitioning; and
means for storing said at least on data fragment within memory locations coupled to said network, wherein said memory locations are assigned by said distributor module.

44. A computer program product comprising a computer useable medium having computer readable code embodied therein for mirroring data on a server within a network, the computer program product adapted when run on a computer to execute steps, including:
executing a distributor module residing on said server;
partitioning a data structure on said server in a random manner;
generating at least one data fragment from said partitioning; and
storing said at least on data fragment within memory locations coupled to said network, wherein said memory locations are assigned by said distributor module.
